(19) United States
(12) Patent Application Publication
(10) Pub. No.: US 2015/0183262 A1
(43) Pub. Date: Jul. 2, 2015

(54) Pencil Sharpening Device with Retractable Pencil Holder

(71) Applicant: Lyle A. Collins, III, Peotone, IL (US)

(72) Inventor: Lyle A. Collins, III, Peotone, IL (US)

(21) Appl. No.: 14/142,798

(22) Filed: Dec. 28, 2013

(51) Int. Cl. B43L 23/00; B43K 23/00

(52) U.S. Cl. CPC B43L 23/00; B43K 23/001

(57) ABSTRACT

The device sharpens and accommodates multiple sizes and types of pencils. The sharpener is affixed to a retractable reel, which is coupled with a rubber adapter, complete with a bore, for a pencil to be housed. The sharpener, varying in composition, is capable of sharpening pencils of varying diameters and sizes, as well as pencils of varying shapes. Appropriately, the device is convenient in providing an all-in-one approach to efficiently and effectively sharpening and retaining a pencil while working.

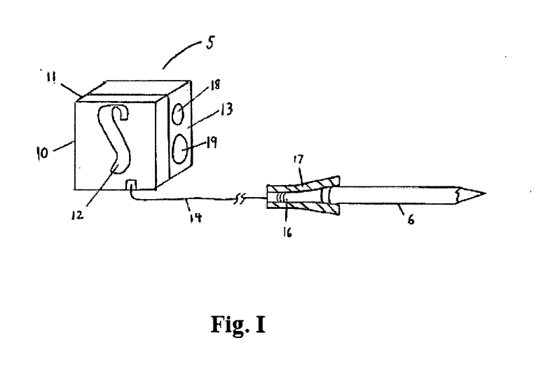

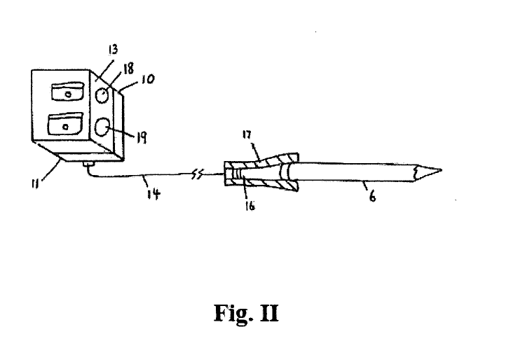

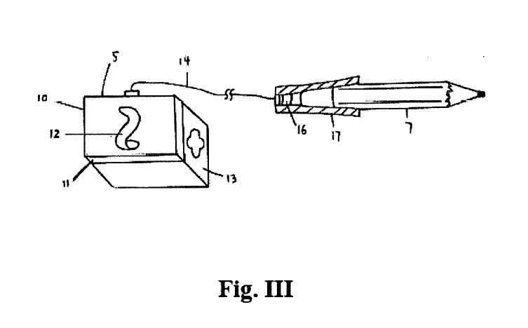

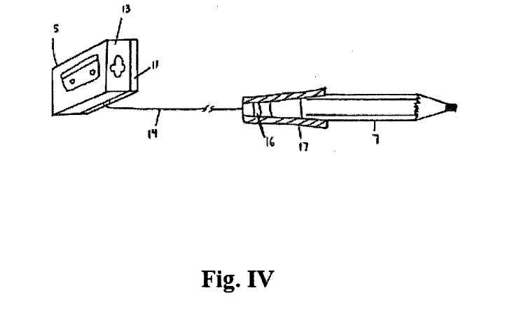

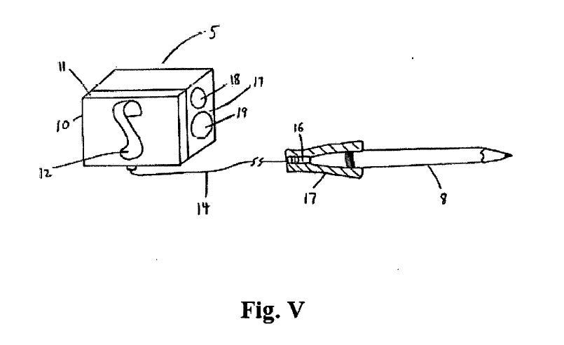

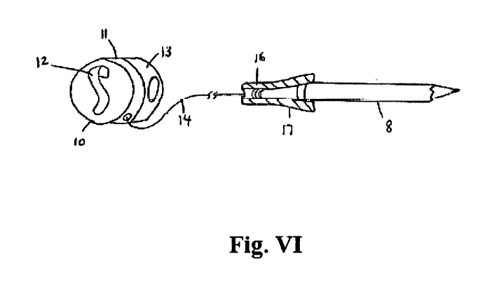

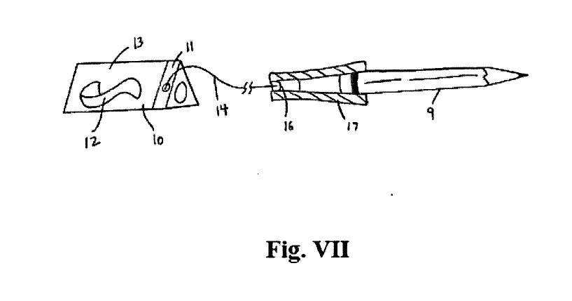

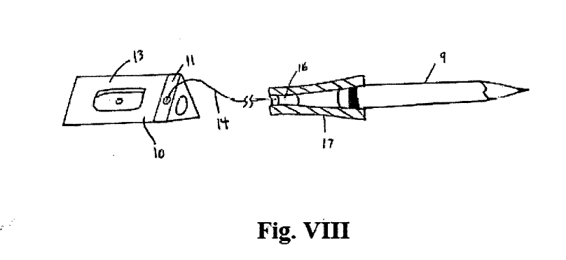

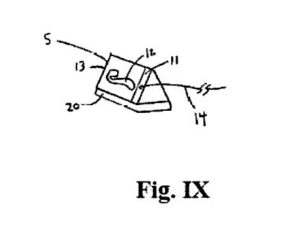

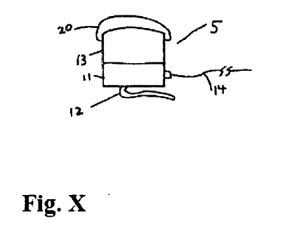

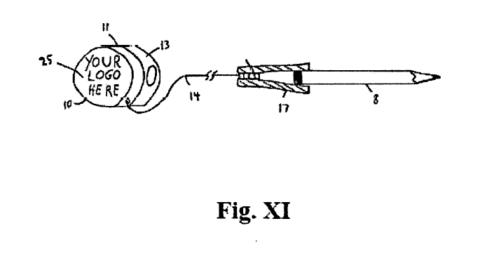

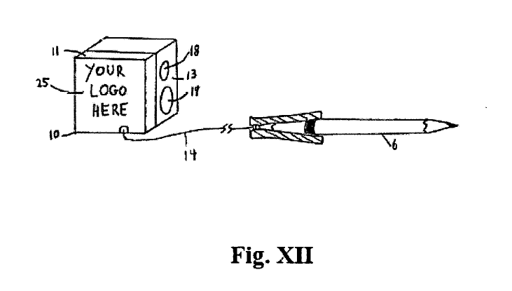

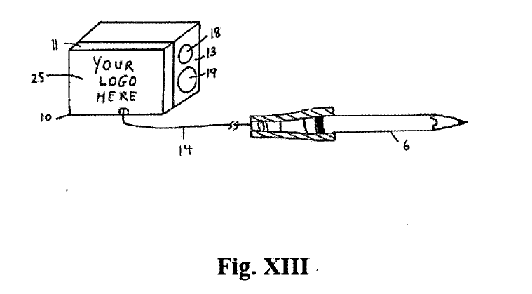

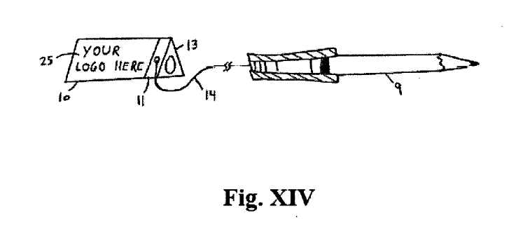

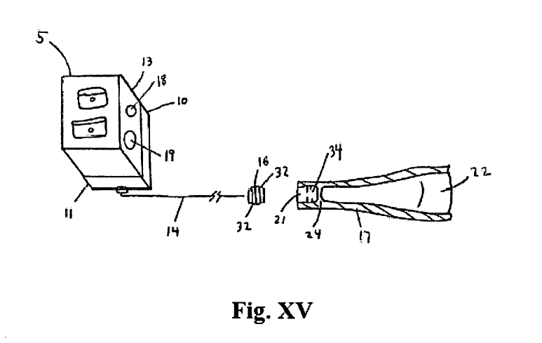

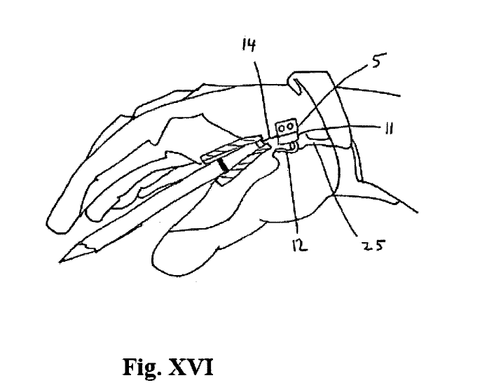

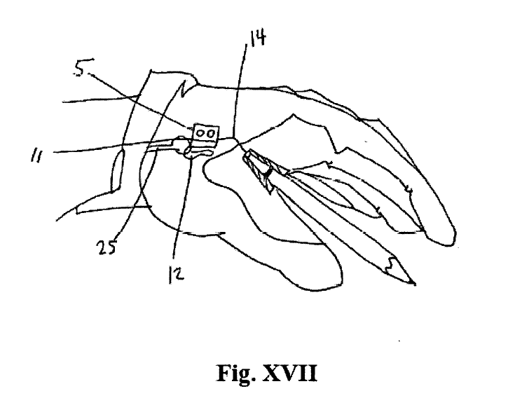

### BACKGROUND

Schools, homeowners, tradesmen, and many others in the workforce employ a pencil as their writing and marking instrument. Often times, the handler may be on a ladder, scaffolding, or another elevated structure and happen to misplace or break the pencil, or too often is left with an unsharpened utensil. Conversely, some focused hobbies and/or responsibilities sanction the need for a device which serves multiple purposes allowing the individual to concentrate on the task at hand. As such, the convenience, accessibility, and condition of a writing utensil are integral, yet credulous components of completing the task at hand. The design of this device provides a practical and functional all-encompassing instrument illustrating convenience, accessibility, and usability of multiple types, sizes, and shapes of pencils and other exemplary embodiments. This invention is an improvement as there is no other all-in-one pencil sharpening device with a retractable pencil holder.

### SUMMARY

Ideal and varying sharpener types accompany a retractable pencil holder which accommodates a writing or marking utensil for any undertaking. Depending on which pencil type is desired, the respective sharpener adheres to the retractable reel. The pencils that may be used consist of multiple shapes, sizes, and characteristics, including but not limited to: carpenter, round, triangular, or hexagonal. When a carpenter pencil is used, the sharpener will possess a single-hole fit to that type of pencil. Use of round, hexagonal, triangular pencils may present a single or dual-holed sharpener, one of a smaller diameter and the other of a larger diameter. The sharpener may or may not have a cover to catch shavings, and the sharpener can be in the form of either an angle and/or flat sharpening composition.

Additionally, this pencil sharpening device with retractable reel conveniently will affix to any type of glove, or other exemplary embodiments. Furthermore, this exemplary embodiment may implore a glove manufactured with the pencil sharpening device with retractable pencil holder already attached, or can be manufactured to affix to a glove and other articles of the like. A flick of the wrist projects the pencil conveniently between the thumb and index finger. The sharpening holes must be placed inward, facing the other hand to easily sharpen the pencil with a free hand.

The retractable reel may be either round, rectangular, or square, by which a similarly shaped sharpener will adhere to said retractable reel. The reverse side of retractable reel may have either a metal or a spring tension clip, alligator clip, adhesive, magnet, or another fastening device to affix to clothing, devices, or surfaces. The cable at the end of the retractable reel employs a rubber fastening device complete with bore to insert the end of the pencil. This rubber embodiment is self-forming and will accept multiple diameter, sizes, and composition of pencils or other exemplary embodiments.

### BRIEF DESCRIPTION OF DRAWINGS

FIG. I is a cross-sectional view of a square dual sharpener with a square retractable reel, capable of engaging either a small or large round, triangular, or hexagonal pencil.

FIG. II is a reverse cross-sectional view of a square dual sharpener with a square retractable reel, capable of engaging either a small or large round, triangular, or hexagonal pencil.

FIG. III is a cross-sectional view of a rectangle sharpener with a rectangle retractable reel, capable of engaging a carpenter pencil.

FIG. IV is a reverse cross-sectional view of a rectangle sharpener with a rectangle retractable reel, capable of engaging a carpenter pencil.

FIG. V is a cross-sectional view of a rectangle dual sharpener with a rectangle retractable reel, capable of engaging a small or large round, triangular, or hexagonal pencil.

FIG. VI is a cross-sectional view of a circular sharpener with a circle retractable reel, capable of engaging a small or large round, triangular, or hexagonal pencil.

FIG. VII is a cross-sectional view of a triangular sharpener with a triangular retractable reel, capable of engaging a small or large round, triangular, or hexagonal pencil.

FIG. VIII is a cross-sectional view of a triangular sharpener with a triangular retractable reel, capable of engaging a small or large round, triangular, or hexagonal pencil.

FIG. IX is an exploded partial sectional view of a triangular sharpener and sharpener cover for shavings catcher.

FIG. X is an exploded partial sectional view of a square or rectangle sharpener and sharpener cover for shavings catcher.

FIGS. XI, XII, XIII, and XIV are perspective views of all exemplary embodiments showing marketing and advertising space.

FIG. XV is an exploded side cross-sectional view of an exemplary embodiment.

FIG. XVI is a perspective view of a right-handed glove, with a square/rectangle sharpener, having sharpening holes face inward.

FIG. XVII is a perspective view of a left-handed glove, with a square/rectangle sharpener, having sharpening holes face inward.

### DETAILED DESCRIPTION

Referring to the drawings, detailed descriptions of various shapes, sizes, and types of sharpeners and pencils are not intended to represent the only forms in which the exemplary embodiments may be constructed and/or utilized.

In the illustrated embodiment depicted in FIGS. I, II, and V the pencil sharpener device 5 has two openings 18 and 19 to accommodate different sized pencils. It should be appreciated that in some embodiments, only a single sharpener opening may be employed for the sharpener. Referring to the drawings in FIGS. I-XV, a sharpening device 5 consists of a pencil sharpener 13 which adheres to the housing 10 and a fastening means 12 for attaching the retractor 11 to clothing, clipboard, visor, pencil holder, glove, tool belt, or a surface. The fastening means 12 may be a belt clip, an alligator clamp, a bulldog clip, a hook, Velcro, any other coupling structure or an adhesive or magnet to affix to any surface. The retractor 11 has an internal retractable reel which connects to a cable 14 that can be extended approximately 2 to 3 feet from the reel. The length of this cable may vary to accommodate various uses.

FIGS. I and II portray a square sharpener affixed to a square retractable reel where FIGS. III, IV, and V portray a rectangle sharpener affixed to a rectangular retractable reel. FIG. VI portrays a round sharpener affixed to a round retractable reel. Furthermore, FIGS. VII and VIII portray a triangular shaped sharpener affixed to a triangle retractable reel. While the shape of the sharpener may be better served to the type of pencil used, user preference may also be relevant. The fastening means 12 of each shape of sharpener may be interchangeable between uses and/or types of sharpeners.

FIG. III displays a carpenter pencil sharpener 13 with the flexible retaining member 17 housing a carpenter pencil. FIG. IV depicts the reverse view of the carpenter pencil sharpener 13. Due to the supple nature of the material of the flexible retaining member 17, varying diameters are allowed into the cavity 22. That being said, the larger the diameter of the instrument inserted into the flexible retaining member 17, inner walls will engage the outer walls to grasp the instrument. Furthermore, the flexible retaining member 17 is capable of engaging instruments having irregular cross-sections as long as the instruments are inserted into the main cavity 22, as shown in FIG. XV, and sufficiently forming a tight frictional fit with the pencil. Additionally, the pencil can be removed from the main cavity 22 with adequate pulling force to overcome the frictional fit and be replaced with another pencil.

FIGS. IX and X depict both a triangular sharpening device 13 as well as a square sharpening device 13 with sharpener cover 20. The sharpener cover 20 can be present on any one of the shapes of sharpening devices 5 and may snap into the sharpening device 13 or by another suitable means. The fastening means 12 will be interchangeable across all sharpening devices 5 when possessing a sharpening cover 20 similarly to a device not possessing a sharpening cover. The triangular model of sharpening device 5 may have a placement of the fastening means 12 on either adjacent side of the sharpener cover while a round, square, or rectangular sharpening device 5 will have the sharpener cover 20 placed on the opposite side of the fastening means 12.

This device presents the opportunity to place a logo or other promotional and advertisement information as displayed in FIGS. XI, XII, XIII, and XIV. The logo or other promotional advertisement has the ability to be placed on the retractor 11 or the sharpener cover 20.

As shown in FIG. XV, perforated metal plug 16 is attached to one end of the cable 14. The plug 16 is inserted into a bore 21 that is positioned at one end of the flexible retaining member 17. According to one embodiment, the plug 16 is held by friction fit against the inner walls of the bore 21. To achieve a friction fit, the diameter of the plug 16 may be slightly larger than the diameter of the bore 21. In other embodiments, the plug 16 having annular ridges 32 may engage and partner with the corresponding annular ridges 34 provided on the bore 21. The plug 16 may have a plurality of shapes and be made from a plurality of materials such as, but not limited to, plastic, metal, alloys, ceramics, or the like.

FIG. XV illustrates the flexible retaining member 17 having a generally funnel-shaped body. The adapter has a bore 21 that is sized to receive a plug 16. The bore 21 may possess smooth inner walls in one exemplary embodiment. In another exemplary embodiment, the walls may have annular ridges 34 extending into the bore 21 as shown in FIG. XV. The flexible retaining member 17 also includes a wall 24 which separates the bore 21 from the main cavity 22. The main cavity 22 has a cross-section that reduces as it approaches the wall 24 that separates the cavity 22 from the bore 21. The reduction of diameter of the main cavity walls presents a universal adapter that is sized to engage a wide variety of pencils of different shapes and diameters to be firmly held by a frictional fit.

FIG. XVI depicts a right-handed work glove, having a slot 25 where a clip 12 can be inserted to attach pencil sharpening retractable device. Slot 25 may encompass other types and methods to affix pencil sharpening retractable device, such as Velcro, bulldog clip, alligator clip, adhesive, or other exemplary embodiments. Note that the holes to sharpen the pencil must face inward so that the pencil may be sharpened easily with the other hand (left).

FIG. XVII depicts a left-handed work glove, having a slot 25 where a clip 12 can be inserted to attach pencil sharpening retractable device. Slot 25 may encompass other types and methods to affix pencil sharpening retractable device, such as Velcro, bulldog clip, alligator clip, adhesive, or other exemplary embodiments. Note that the holes to sharpen the pencil must face inward so that the pencil may be sharpened easily with the other hand (right).

While exemplary embodiments of the sharpener and retractable instrument holder were described with regards to various embodiments, supplementary shaped sharpeners, retractable reels, and pencil holders may be devised without desertion from the model.

Having described my invention, I claim:

1. A pencil sharpening device including a sharpener, retractable pencil holder, comprising:
a pencil sharpener affixed to the retractable reel housing, the cable having a first end positioned within the retractor body and a second end positioned outside the retractor body, the cable having a protuberance coupled to the second end, and wherein the cable is selectively extendable from the retractor body and into the retractable body, wherein the pencil sharpener is affixed to the retractable reel housing; and
a retaining device connected to said housing for releasably retaining said housing to the person's body, glove, clothing, desired surface;
an adapter coupled to the protuberance, the adapter comprising a main body having a first portion and a second portion, wherein the first portion and the second portion are separated by a partition; the first portion defining a first bore having a substantially constant diameter, and the second portion defining a second bore having a tapered inner bore;
a holder connected to said second end of said flexible member for firmly, but releasable attaching the writing instrument to said second end to form a tight frictional engagement between the writing instrument and said holder member;

2. The pencil sharpening device of claim 1, wherein the adapter is coupled to the protuberance by an adhesive.

3. The pencil sharpening device of claim 1, wherein the adapter is coupled to the protuberance by a friction fit.

4. The pencil sharpening device of claim 1, wherein the protuberance includes one or more annular ridges extending from outer surface of protuberance.

5. The pencil sharpening device of claim 1, wherein the protuberance is provided with threads that mate with walls of the first bore.

6. The pencil sharpening device of claim 1, wherein the protuberance is sized to engage the walls of the walls of the first bore.

7. The pencil sharpening retractable device of claim 6, wherein the first bore is provided with at least one ridge projecting away from the walls of the first bore.

8. The pencil sharpening retractable device of claim 1, wherein the second bore is provided with at least one ridge projecting away from the walls of the second bore.

9. The pencil sharpening retractable device of claim 1, wherein the tapered inner bore of the second portion of the adapter is funnel-shaped.

10. The pencil sharpening retractable device of claim 1, wherein the tapered inner bore of the second portion of the adapter is bottleneck-shaped.

11. The pencil sharpening retractable device of claim 1 further comprising an elongated rod that is coupled to the pencil sharpener/retractable body, the elongate rod sized to engage a bore of press-in clip bracket.

12. A pencil sharpening device including a sharpener, retractable pencil holder that does not drop to the ground if released comprising:
a sharpening device to sharpen attached pencil, complete with retaining device, attached to a person's body, glove, clothing, or surface;
a flexible member holding device which includes a housing and an elongated flexible member having a first end connected to said housing and second end which is extendible from and retractable to said housing;
a retractor comprising a retractor body that houses a cable that is selectively extendable from and retractable into the retractor body, and a protuberance provided at a first end of the cable; and
an adapter comprising a main body having a first portion and a second portion, wherein the, first portion and the second portion are separated by an inner wall;
the first portion defining a first bore having a substantially constant diameter wherein the first bore engages the protuberance, and the second portion defining a second bore having a funnel-shaped inner bore that is capable of engaging an outer wall of the writing instrument.
a holder connected to said second end of flexible member for firmly, but releasably attaching the pencil to the second end;

13. The pencil sharpening retractable device of claim 12, further comprising a fastening means coupled to the retractor, opposite of the sharpener.

14. The pencil sharpening retractable device of claim 13, wherein the fastening means is an elongated rod sized to engage a bore or a press-in clip bracket.

15. A pencil sharpening retractable device including a sharpener, retractable pencil holder, comprising:
a retractor comprising a retractor body coupled to a fastening means and retractor body that houses a cable, the cable having a first end positioned within the retractor body and a second end positioned outside the retractor body, the cable having a protuberance having annular ridges extending from an outer surface of the protuberance, wherein the protuberance is coupled to the second end, and wherein the protuberance is coupled to the second end, and wherein the cable is selectively extendable from the retractor body and retractable into the retractable body; and
a flexible adapter comprising a main body having a first portion and a second portion, wherein the first portion and the second portion are separated by an inner wall; the first portion defining a first bore having a substantially constant diameter wherein the first bore engages the protuberance by a friction fit, and the second portion defining a second bore having a funnel-shaped inner bore that is capable of engaging and retaining the pencil, writing instrument.

16. The pencil sharpening retractable device of claim 15, wherein the fastening means is a belt clip, an alligator clamp, a bulldog clip, a hook, Velcro, any other coupling structure or an adhesive or magnet to affix to any surface.

17. The pencil sharpening retractable device of claim 16, wherein the fastening means is an elongated rod sized to engaged a bore or a press-in clip bracket.
